(19) United States
(12) Patent Application Publication
(10) Pub. No.: US 2012/0098662 A1
(43) Pub. Date: Apr. 26, 2012

(54) SAFETY SYSTEM, METHOD, AND ELECTRONIC GATE WITH THE SAFETY SYSTEM

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/960,334

(22) Filed: Dec. 3, 2010

(30) Foreign Application Priority Data
Oct. 22, 2010 (TW) 99136091

(51) Int. Cl. G08B 13/08; G06F 7/04

(52) U.S. Cl. 340/545.1; 340/5.7

(57) ABSTRACT

An electronic gate includes a foldable portion, a motor, a camera, a switch, and a safety system. The foldable portion is located between a first support and a second support. The motor controls the foldable portion. The camera captures an image between the first support and the second support. The safety system is to check the image captured by the camera to determine whether there are people between the first support and the second support, and control the switch to cut off a power supply with the motor according to the determination result.

### BACKGROUND

1. Technical Field

The present disclosure relates to an electronic gate with a safety system, and a safety method for the electronic gate.

2. Description of Related Art

An electronic gate is used to stop or allow someone to enter or leave a compound or premises. Sometimes, people usually try to pass through the electronic gate quickly while the electronic gate is closing, which may result in injury to these people.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an exemplary embodiment of an electronic gate.

FIG. 2 is a block diagram of the electronic gate of FIG. 1, the electronic gate includes a safety system including a storage unit.

FIG. 3 is a block diagram of the storage unit of FIG. 2.

FIG. 4 is a flowchart of an exemplary embodiment of a safety method for an electronic gate.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

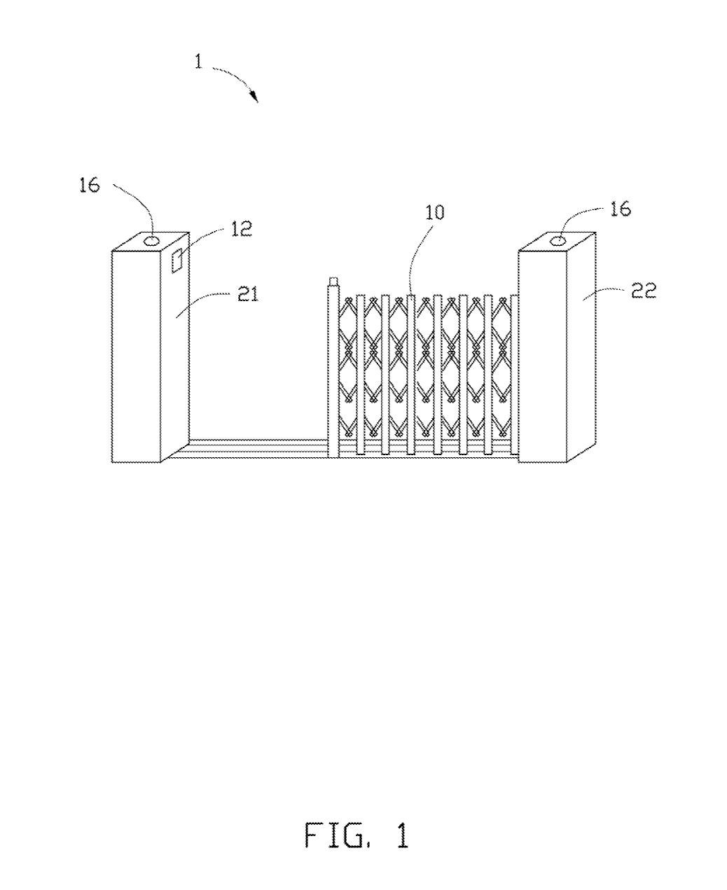

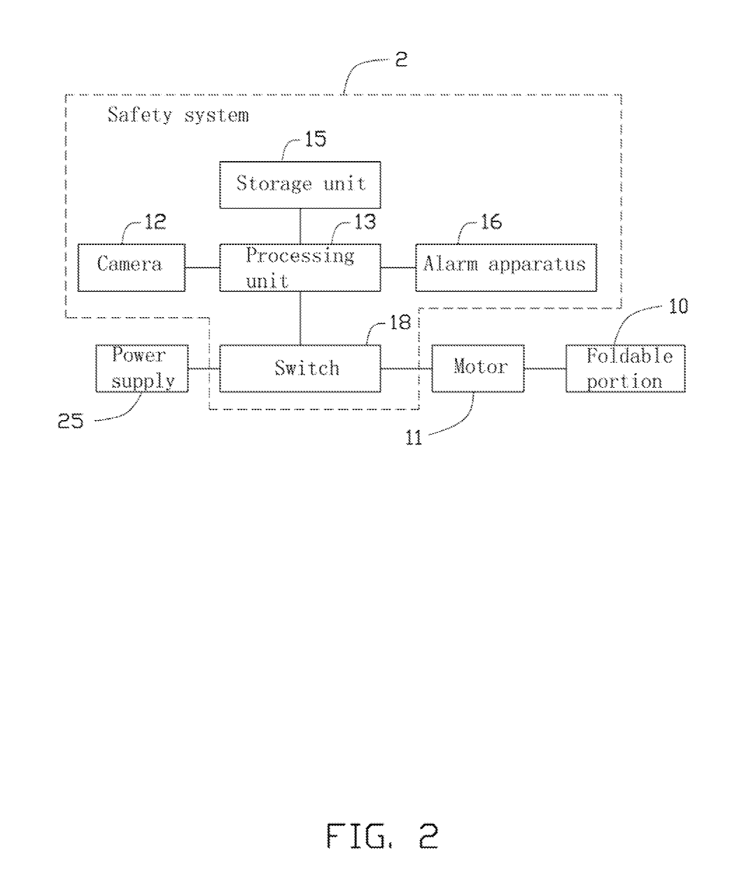

Referring to FIGS. 1 and 2, an exemplary embodiment of an electronic gate 1 is a transversely folding electronic gate. In other embodiments, the electronic gate 1 may be a longitudinal folding electronic gate. The electronic gate 1 includes a foldable portion 10, a motor 11, and a safety system 2. The safety system 2 includes a camera 12, a processing unit 13, a storage unit 15, two alarm apparatus 16, and a switch 18.

The foldable portion 10 is mounted between a first support 21 and a second support 22. A first end of the foldable portion 10 is fixed to the second support 22. A second end of the foldable portion 10 contacts with and is able to separate from the first support 21 under control of the motor 11. As a result, the electronic gate 1 can be closed or opened to stop or allow one to pass through the electronic gate 1.

The camera 12 is mounted on a side of the first support 21, to capture an image of a scene between the first support 21 and the second support 22. The two alarm apparatus 16 are mounted on the top surfaces of the first support 21 and the second support 22 respectively. The switch 18 cuts off or connects the motor 11 to a power supply 25. In other embodiments, the camera 12 can be mounted on the second end of the foldable portion 10 to capture an image of a scene at the front of the second end of the foldable portion 10. In addition, two cameras 12 can be respectively mounted on the second end of the foldable portion 10 and the side of the first support 21. Moreover, the safety system 2 may include only one alarm apparatus 16. The alarm apparatus 16 can be mounted on the top surface of the first support 21 or the second support 22.

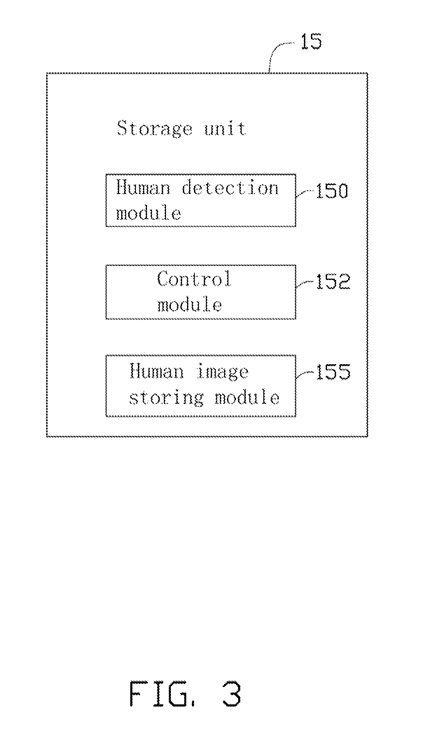

Referring to FIG. 3, the storage unit 15 includes a human detection module 150, a control module 152, and a human image storing module 155, which may include one or more computerized instructions executed by the processing unit 13.

The human image storing module 155 stores a number of images for different shapes of different people. The cameras may obtain the different human images in advance.

The human detection module 150 checks images captured by the camera 12 to determine whether there is a person between the first support 21 and the second support 22. The human detection module 150 analyzes the images using well known human recognition technology. In the embodiment, the human detection module 150 compares the image captured by the camera 12 with the different human images stored in the human image storing module 155 to determine whether there is a person between the first support 21 and the second support 22. If a portion of the image captured by the camera 12 is similar to a human image of the human images stored in the human image storing module 155, it is determined that there is a person in the image, namely, there is a person between the first support 21 and the second support 22. If the image captured by the camera 12 is different from all human images stored in the human image storing module 155, it is determined that there are no people in the image, namely, there are no people between the first support 21 and the second support 22. In addition, the human image storing module 155 may further store a number of different animals images, such as cats or dogs. The human detection module 150 may further determine that whether there is an animal between the first support 21 and the second support 22.

When the human detection module 150 determines that there is a person between the first support 21 and the second support 22, the control module 152 activates the alarm apparatus 16, such as a blinking LED, and controls the switch 18 to cut off power from the motor 11. After the switch 18 cuts off the power and a preset interval of time, such as 5-10 seconds, elapses, the human detection module 150 checks the image from the camera 12 to determine whether the person is still between the first support 21 and the second support 22. If the person is still between the first support 21 and the second support 22, the control module 152 still activates the alarm apparatus 16 and controls the switch 18 to cut off power from the motor 11. If there is no person between the first support 21 and the second support 22, the control module 152 then controls the switch 18 to reconnect the power supply 25 to the motor 11, and deactivates the alarm apparatus 16.

As a result, when there is a person between the first support 21 and the second support 22, the control module 152 cuts off power from the motor 11 to stop the electronic gate 1 from working, thus to ensure the safety of the person.

The alarm apparatus 16 acts as an indicator to operators that the safety system 2 has been activated and is the cause of loss of power to the motor 11. When the alarm apparatus 16 is activated, it indicates that the safety system 2 is activated, and the motor 11 is powered down. If the motor 11 is unexpectedly powered down, an operator will know right away it is not because of the safety system 2 if the alarm apparatus 16 is not activated, some other problem exists.

When the human detection module 150 determines that there is no people between the first support 21 and the second support 22, the alarm apparatus 12 is deactivated, and the switch 18 connects the power supply 25 to the motor 11.

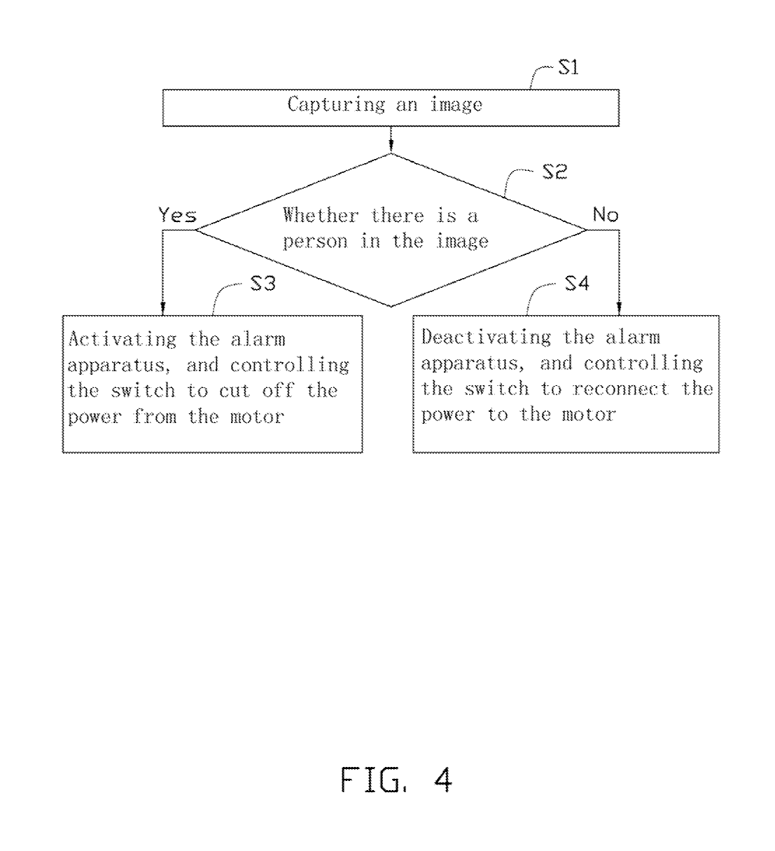

FIG. 4 shows a safety method for the electronic gate 1, which includes the following:

In step S1, the camera 12 captures an image.

In step S2, the human detection module 150 checks the image captured by the camera 12 to determine whether there is a person between the first support 21 and the second support 22. If it is determined that there is people between the first support 21 and the second support 22, the process flows to step S3. If it is determined that there is no people between the first support 21 and the second support 22, the electronic gate 1 continues to operate, and the process flows to step S4.

In step S3, the control module 152 activates the alarm apparatus 16, and controls the switch 18 to cut off the power from the motor 11.

In step S4, the control module 152 controls the switch 18 to reconnect power to the motor 11, and deactivates the alarm apparatus 16. Then the process flows to step S1.

The safety system software can also be used on other tools, such as an anesthesia gun.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A safety system for an electronic gate, the electronic gate located between a first support and a second support, the safety system comprising:
a camera to capture an image between the first support and the second support;
a switch to cut off or connect a power supply from or to the electronic gate;
a processing unit; and
a storage unit connected to the processing unit, the camera, and the switch, and storing a plurality of programs to be executed by the processing unit, wherein the storage unit comprises:
a human detection module to check the image captured by the camera to determine whether there is a person between the first support and the second support; and
a control module to control the switch to cut off the power supply to the electronic gate upon the condition that there is a person between the first support and the second support.

2. The safety system of claim 1, wherein the control module controls the switch to connect the power supply to the electronic gate upon the condition that there is no person between the first support and the second support.

3. The safety system of claim 1, further comprising an alarm apparatus, wherein the control module activates the alarm apparatus upon the condition that there is a person between the first support and the second support.

4. The safety system of claim 3, wherein the control module deactivates the alarm apparatus upon the condition that there is no person between the first support and the second support.

5. The safety system of claim 1, wherein the storage system further comprises a human image storing module storing a number of images for different shapes of different people, the human detection module compares the image captured by the camera with the human images stored in the human image storing module to determine whether there is a person between the first support and the second support.

6. A safety method for an electronic gate, the electronic gate located between a first support and a second support, the method comprising:
capturing an image between the first support and the second support;
checking the image to determine whether there is a person between the first support and the second support; and
controlling a switch to cut off a power supply to the electronic gate upon the condition that there is a person between the first support and the second support.

7. The safety method of claim 6, further comprising:
controlling the switch to connect the power supply to the electronic gate upon the condition that there is no person between the first support and the second support.

8. The safety method of claim 5, further comprising:
controlling an alarm apparatus to work upon the condition that there is a person between the first support and the second support.

9. The safety method of claim 7, further comprising:
deactivating the alarm apparatus upon the condition that there is no person between the first support and the second support.

10. The safety method of claim 6, wherein “detecting the image from the camera to determine whether there is a person between the first support and the second support” comprises:
comparing the image captured by the camera with the human images stored in advance to determine whether there is a person between the first support and the second support.

11. An electronic gate comprising:
a folding portion located between a first support and a second support;
a motor to control the folding portion;
a camera to capture an image between the first support and the second support;
a switch; and
a safety system to check the image captured by the camera to determine whether there is a person between the first support and the second support, and control the switch to cut off a power supply with the motor according to the determination result.

12. The electronic gate of claim 11, wherein the safety system comprises:
a processing unit; and
a storage unit connected to the processing unit, the camera, and the switch, and storing a plurality of programs to be executed by the processing unit, wherein the storage unit comprises:
a human detecting module to check the image captured by the camera to determine whether there is a person between the first support and the second support; and
a control module to control the switch to cut off the power supply from the motor upon the condition that there is a person between the first support and the second support.

13. The electronic gate of claim 12, wherein the control module controls the switch to connect the power supply to the electronic gate upon the condition that there is no person between the first support and the second support.

14. The electronic gate of claim 12, further comprising an alarm apparatus, wherein the control module activates the alarm apparatus upon the condition that there is a person between the first support and the second support.

15. The electronic gate of claim 14, wherein the control module deactivates the alarm apparatus upon the condition that there is no person between the first support and the second support.

16. The electronic gate of claim 12, wherein the storage system further comprises a human image storing module storing a number of images for different shapes of different people, the human detection module compares the image captured by the camera with the human images stored in the human image storing module to determine whether there is a person between the first support and the second support.
